(19) United States
(12) Patent Application Publication
(10) Pub. No.: US 2009/0326861 A1
(43) Pub. Date: Dec. 31, 2009

(54) DOSE COUNTING SCALES FOR A MEDICAL INHALER

(76) Inventors: Stanley C. Langford, Harrow (CA); Eric Fugelsang, Fishkill, NY (US)

Correspondence Address: LAUBSCHER & LAUBSCHER, P.C., 1160 SPA ROAD, SUITE 2B, ANNAPOLIS, MD, 21403, US

(21) Appl. No.: 12/472,454

(22) Filed: May 27, 2009

Related U.S. Application Data
(60) Provisional application No. 61/075,700, filed on Jun. 25, 2008.

(51) Int. Cl. G01G 9/00

(52) U.S. Cl. 702/173

(57) ABSTRACT

Disclosed is a dosage device for determining the number of remaining doses of medication available in a medical inhaler, comprising a sensitive electronic weigh scale capable of recording measurements at least as small as 0.001 grams for providing an output signal dependent on the weight of a medical inhaler, or the canister of a medical inhaler, placed on the weigh scale; a memory containing a data structure in the form of a table storing shot weight, new inhaler weight, tare weight and total number of doses for each of a plurality of different medical inhalers; and input device for permitting a user to select one of said plurality of medical inhalers; a processor configured to read the shot weight, new inhaler weight, tare weight, and total number of doses from said memory for the selected medical inhaler, and said processor being configured to calculate the number of doses remaining in the medical inhaler by either: determining the weight as sensed by said weigh scale, subtracting the weight of a new inhaler from the measured weight, and dividing the resulting weight by the shot weight, the result of which is then added to the number of doses; or by determining the weight as sensed by said weigh scale, subtracting the tare weight, and dividing the resulting net weight by the shot weight; and a display device configured to display the remaining number of doses determined by said processor.

### CROSS-REFERENCE TO RELATED APPLICATION

This application claims the benefit of U.S. Provisional Application No. 61/075700 filed Jun. 25, 2008, incorporated by reference herein.

### FIELD OF THE INVENTION

The present invention relates to medical inhalers. More specifically, the present invention relates to a dosage device for determining the remaining contents in a medical inhaler.

### BACKGROUND OF THE INVENTION

Medical inhalers are used to administer medication to a user's body via the lungs or nasal passageways, and are commonly used by asthma and COPD sufferers to alleviate the symptoms of their disease. Inhalers are typically comprised of an outer casing or shell, a dust cap and a canister containing a certain number of doses of medication (actuations or puffs). The canister contains a metering valve that ensures that the correct volume of medication and propellant is contained in each actuation.

Clearly, it is important that an inhaler be replaced when its doses have been expended Until recently, patients prescribed inhalers had no accurate method to determine the remaining doses in their inhaler except to keep a written record of each time the used the devices. Early add on devices were developed to count the number of actuations by measuring the sudden change in temperature or air pressure at the mouth of the inhaler, due to the rapid expansion of gases. These counting devices were proven to be expensive, bulky, sometimes unreliable, and were not adaptable to many popular inhalers. One widely accepted method to measure the contents of an inhaler was to place the canister in a basin of water and based on the amount of buoyancy the user could roughly estimate the volume of medicine remaining. Early in the 21^{st} century, however, CFC propellants were virtually eliminated from inhalers and replaced with non-ozone depleting aerosols changing the float characteristics of the canister. Accordingly, without CFCs, the “float test” is no longer a useful way of determining the amount of medication remaining.

Pressurized metered dose inhalers (pMDI) are drug delivery devices in which the contents are metered as they are dispensed. However, a disadvantage of such devices is that there is no way for the user to measure or judge the quality of its content as the inhaler reaches the end of its useful life. After the active medical ingredients are gone, the taste, pressure and plume of the spray can typically remain constant for up to 20 doses past the published number of doses before they begin to gradually taper off. At this point, the drop off is usually nominal and the time between actuations (doses) is so long that it is virtually impossible for the user to discern the small variations in output. Accordingly, in order to ensure an accurate amount of medicine in the last dose, the inhaler has to be overfilled by the manufacturer. Consequently, it continues to work after the prescribed number of doses, but those remaining doses may not contain enough active ingredients to alleviate the patient's symptoms. Many asthmatics wrongly believe their inhalers are still delivering an adequate amount of medication and continue to rely on it until it is completely empty. Today, drug manufacturers have developed pMDIs with built in counting devices, but these have made inhalers more complex to manufacture and increased the purchase price to the consumer. Consequently, few jurisdictions have adopted this technology.

Without an accurate, cost effective means to determine the amount of medication remaining in an inhaler, users are at risk of not getting enough medication to treat their ailment. In fact, recent studies found that almost half of all asthmatics use their inhaler until it is completely empty. The same study determined that as many as 10% of all asthmatics show up at emergency rooms with a completely empty inhaler. Conversely, research has also shown that a large percentage of the inhalers are discarded annually with a significant number of doses remaining unused.

### SUMMARY OF THE INVENTION

Embodiments of the present invention provide a solution to the problem of determining the remaining contents in a medical inhaler. In general terms, a dose counting scale is used in conjunction with a complete pMDI (canister and housing) or the canister of a pMDI alone. Each specific brand of inhaler has a specific number of doses that is dispensed by volume but can be expressed by weight. Inhaler canisters, housings (or bodies) and caps all have specific weights. Most importantly for the purposes of this invention, the contents of the inhaler canister, though often expressed by volume, have specific content and “shot” weights. In some cases, inhalers of the same brand are often available in different dose counts containing different amounts of active ingredients. This in turn, provides unique full weights and consequently unique tare weights associated with each inhaler. Tare weight is defined as the weight of a new primed inhaler after its stated number of doses has been actuated (zero doses remaining) As previously mentioned, the weight of each dose, referred to as shot weight, is also unique to its brand. Calculating the number of doses remaining is achieved by weighing the inhaler, subtracting the tare weight from the measured weight of the inhaler, and then dividing the resultant by the shot weight The answer is an accurate assessment of the remaining doses. Another valid method of determining remaining doses would be to subtract the full weight of the inhaler from its measured weight, then dividing the resultant by the shot weight and adding the original number of doses. The same results can be achieved by simply repeating the above-instructions, substituting only the canister of the inhaler for the complete device. Of course new full weights and tare weights have to be established for the canister alone This method, though not always possible, has certain advantages, as the number of doses would be significantly misrepresented if the user would forget to replace the cap, or the pharmacy has placed additional labels on the shell or body altering its initial weight. Scales can be mechanical or electronic.

Thus, according to one aspect, the invention provides a dosage device for determining the number of remaining doses of medication available in a medical inhaler, comprising a sensitive weigh scale capable of recoding measurements at least as small as 0.001 grams for outputting a measured weight dependent on the weight of a medical inhaler placed on the weigh scale; a memory containing a data structure in the form of a table storing a plurality of records corresponding to different medical inhalers, and each record containing data allowing the number of remaining doses to be determined from the measured weight of the inhaler; an input device for permitting a user to select one of said plurality of medical inhalers stored in said data structure; a processor configured to read said data stored in a record pertaining to a particular medical inhaler, and said processor being configured to determine the number of doses remaining from said stored data and the measured weight; and a display device configured to display the remaining number of doses determined by said processor.

In one embodiment the memory serves as a look-up table, and the processor determines the number of doses remaining by comparing the measured weight against the values stored in the table.

In another embodiment the stored data in each record includes shot weight, new weight and the total number of doses for each of a plurality of different medical inhalers, and the processor retrieves this data from said memory for a particular medical inhaler and calculates the number of doses remaining in the medical inhaler by determining the sample weight as measured by said weight scale, then subtracting the new weight, and dividing the resultant by the shot weight and adding the total number of doses. The result is the total number of doses remaining. A simplified version of this look up table would have calculated the tare weight for each inhaler in which case simply subtracting the tare weight from the sample weight and dividing by the shot weight would give you the number of doses remaining.

The invention can also be used with dry powder inhalers, nasal inhalers or inhalers not involving the use of a propellant or other non-medically active ingredients. In this case, the weight of the active ingredients may be measured in micrograms rather than milligrams and for use with such devices the dose device may need to have a sensitivity in excess of 0.0001 grams.

In one embodiment, said processor is further configured to accept user input from said input device pertaining to the shot weight, tare weight and total number of doses for new medical inhalers, and to add said shot weight, tare weigh, and total number of doses for said new medical inhalers to said data structure in said memory for later retrieval.

In one embodiment, the display device presents a warning characteristic when the remaining number of doses falls below a first predetermined number. Optionally, said warning characteristic takes the form of a change in color of the display. The display device may present a second warning characteristic when the remaining number of doses falls below a second predetermined number. The display may turn amber when the remaining number of doses falls below the first predetermined number and red when the remaining number of doses falls below the second predetermined number

In one embodiment, the device comprises additional memory, and said processor is configured to store in said additional memory the number of doses consumed over time to permit the amount of medication usage to be monitored, Because many asthma sufferers often use more than one medication, additional memory is available for each of the listed inhalers. Optionally, the device comprises an output port for uploading said data to a remote monitoring site for access by a health care professional or for graphing and data analysis.

The weigh scale is preferably electronic, but it can also be mechanical with a transducer to convert the output to an electronic signal. It can also be entirely mechanical, in which case a separate device would be required for each inhaler on the market.

In another aspect there is provided a dosage device for determining the number of remaining doses of medication imbedded available in a medical inhaler, comprising a sensitive weigh scale capable of recoding measurements at least as small as 0.001 grams: a mechanical readout for displaying the remaining doses in the medical inhaler based on the measured weight of the inhaler.

There are many advantages in using a dosage device in accordance with the teachings of this invention. Such a dosage device is usable by patients, their caregivers and health care professionals, to determine the remaining doses in an inhaler leading to improved outcomes, monitoring, compliance and a level of accurate information that has been previously unavailable. Lack of patient compliance to a medical regime either due to ignorance or neglect has always been a concern of medical professionals.

Using a dosage device in accordance with the teachings of this invention provides the most accurate dosage readings currently available, which may ultimately improve the welfare of users.

Other aspects and advantages of embodiments of the invention will be readily apparent to those ordinarily skilled in the art upon a review of the following description.

### BRIEF DESCRIPTION OF THE DRAWINGS

The invention will now be described in more detail, by way of example only, with reference to the accompanying drawings, in which:

FIG. 1 is a diagrammatic illustration of a dosage device in accordance with the teachings of this invention;

FIG. 2 is a functional block diagram of a dosage device in accordance with one embodiment of the invention.

FIG. 3 is a flow chart describing the program implemented by the processor; and

FIG. 4 is a flow chart describing a warning routine.

### DETAILED DESCRIPTION OF THE DISCLOSED EMBODIMENTS

This invention will now be described in detail with respect to certain specific representative embodiments thereof, the materials, apparatus and process steps being understood as examples that are intended to be illustrative only. In particular, the invention is not intended to be limited to the methods, materials, conditions, process parameters, apparatus and the like specifically recited herein.

Disclosed is a dosage device for determining the number of remaining doses of medication available in a medical inhaler. Embodiments of the present invention are based on the premise that a predetermined total weight is known for each specific brand of inhaler when full. Inhalers of the same brand or composition also come in different dose counts, which in turn, have a unique tare weight when full The weight of each dose, referred to as shot weight, is also unique to its brand. For example, pressurized metered dose inhalers (pMDIs) actually measure each dose by volume rather than by weight, but there is a specific weight associated with each dose. Each inhaler manufacturer has their own proprietary formula for their brand of medication. Therefore the weight may vary for two types of inhaler even though their metering valves are of the same size. Therefore the physical characteristics may vary for two types of inhalers with the same active ingredient. As well, inhalers from the same manufacturer with different doses may be fitted with different valves to ensure the most efficient delivery of the drug, and therefore, have different shot weights, gross weights, tare weights, and sometimes number of doses.

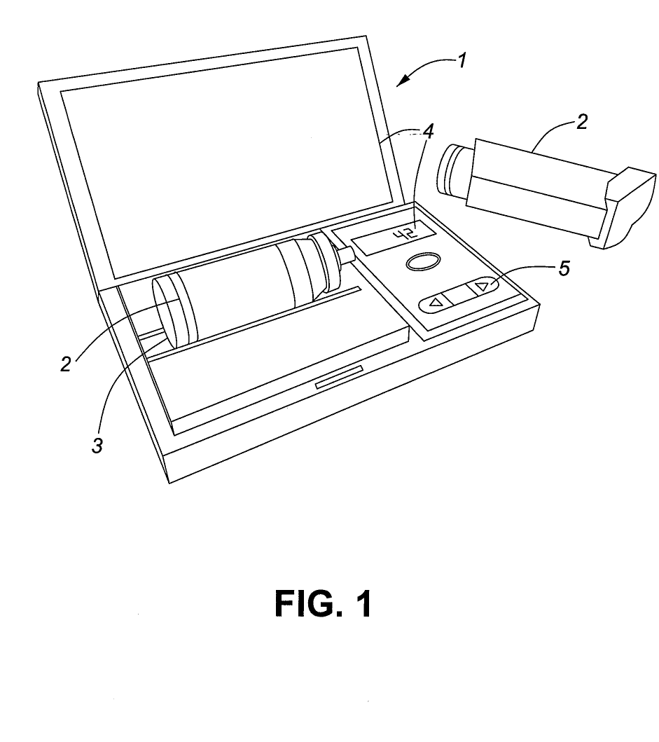

Referring to FIG. 1, a dosage device in accordance with the teachings of this invention comprises a set of scales 1. The scales include a weigh tray 3 for accommodating an inhaler 2 and a display 4. A membrane-style input pad 4 allows for user input. While the dosage device can be purely mechanical, the described device is electronic and gives a read-out in display window 4 of the number of doses remaining.

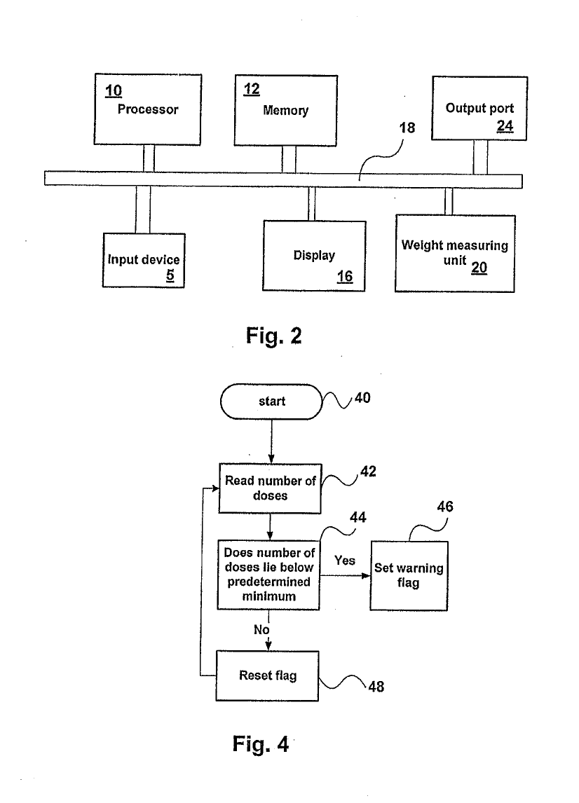

As shown in FIG. 2, the electronic components of the dosage device include a processor 10, memory 12, input device 5, and display device 16 connected to a central bus 18. Weight measuring unit 20 provides an output signal to the bus 18 indicative of the weight of the inhaler placed on the scales. In the mechanical embodiment, a transducer is provided to convert the output of the scales to an electronic form that can be understood by the processor 10.

The memory 12 stores programming instructions as described with reference to FIG. 2 as well as a data structure as explained below. The memory 12 can be any suitable form of memory, and may include a volatile portion, and non volatile portion for storing the programming instructions and data structure.

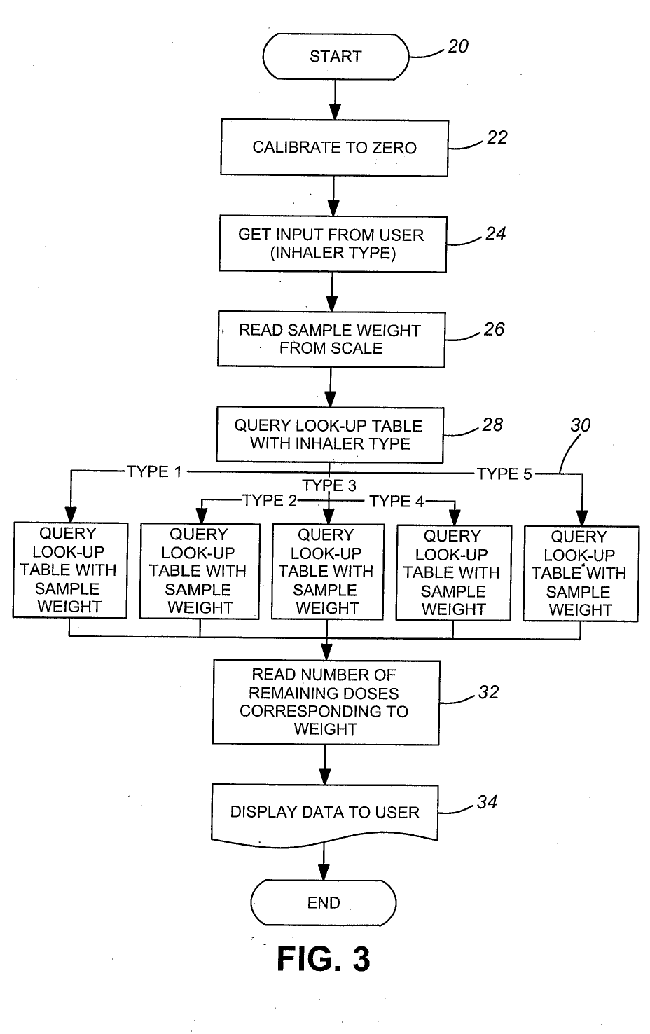

FIG. 3 is a flow chart broadly illustrating the operation of the dosage device. The program starts at block 20. At first step 22, the dosage device is calibrated to zero. Then at step 24, the user places the inhaler on weigh scales 20 and inputs the inhaler type via input device 14. At step 26, the dosage device then weighs the inhaler using weight scales 20. At step 28, the processor 10 queries the data structure to determine the inhaler type.

Next, the processor queries the look-up table based on the sample type determined in step 28 for the sample weight. The following Table 1 illustrates an exemplary lookup table stored in memory 12. The lookup tables will contain as many columns as there are inhalers available in a particular market. In one jurisdiction there may be 10 or less inhalers available, while in another jurisdiction there may be 20 or more. The look-up table may accommodate over 1,000 inhalers. Only the first few records are shown for the purpose of illustration, but it will be appreciated that the number of doses column continues to zero for the consumer version of the device, and all the way until the inhaler is completely empty for the scientific/research version of the scale. It is noted that at a point below the tare weight (zero doses remaining) the shot weight is no-longer constant and tapers off as the inhaler empties.

TABLE 1a

| Inhaler | | Inhaler | | Inhaler | | Inhaler | | Inhaler | |
|---|---|---|---|---|---|---|---|---|---|
| Brand A | | Brand B | | Brand C | | Brand E | | Brand F | |
| Weight | # Doses | Weight | # Doses | Weight | # Doses | Weight | # Doses | Weight | # Doses |
| 25.50 | 200 | 36.00 | 200 | 32.00 | 100 | 25.50 | 200 | 40 | 200 |
| 25.47 | 199 | 35.94 | 199 | 31.94 | 99 | 25.47 | 199 | 39.93 | 199 |
| 25.44 | 198 | 35.89 | 198 | 31.88 | 98 | 25.44 | 198 | 39.85 | 198 |
| 25.41 | 197 | 35.83 | 197 | 31.82 | 97 | 25.41 | 197 | 39.78 | 197 |
| 25.38 | 196 | 35.78 | 196 | 31.76 | 96 | 25.38 | 196 | 39.70 | 196 |
| 25.35 | 195 | 35.72 | 195 | 31.71 | 95 | 25.35 | 195 | 39.63 | 195 |
| 25.32 | 194 | 35.66 | 194 | 31.65 | 94 | 25.32 | 194 | 39.55 | 194 |
| 25.29 | 193 | 35.61 | 193 | 31.59 | 93 | 25.29 | 193 | 39.48 | 193 |
| 25.26 | 192 | 35.55 | 192 | 31.53 | 92 | 25.26 | 192 | 39.40 | 192 |
| 25.23 | 191 | 35.50 | 191 | 31.47 | 91 | 25.23 | 191 | 39.33 | 191 |
| 25.20 | 190 | 35.44 | 190 | 31.41 | 90 | 25.20 | 190 | 39.25 | 190 |
| 25.17 | 189 | 35.38 | 189 | 31.35 | 89 | 25.17 | 189 | 39.18 | 189 |
| 25.14 | 188 | 35.33 | 188 | 31.29 | 88 | 25.14 | 188 | 39.10 | 188 |
| 25.11 | 187 | 35.27 | 187 | 31.23 | 87 | 25.11 | 187 | 39.03 | 187 |

TABLE 1b

| Inhaler Brand G | | Inhaler Brand H | | Inhaler Brand J | | Inhaler Brand K | |
|---|---|---|---|---|---|---|---|
| Weight | # Doses | Weight | # Doses | Weight | # Doses | Weight | # Doses |
| 28 | 120 | 28 | 120 | 40 | 200 | 25 | 120 |
| 27.94 | 119 | 27.93 | 119 | 39.93 | 199 | 24.94 | 119 |
| 27.88 | 118 | 27.85 | 118 | 39.86 | 198 | 24.89 | 118 |
| 27.82 | 117 | 27.78 | 117 | 39.79 | 197 | 24.83 | 117 |
| 27.76 | 116 | 27.70 | 116 | 39.72 | 196 | 24.78 | 116 |
| 27.70 | 115 | 27.63 | 115 | 39.65 | 195 | 24.72 | 115 |
| 27.64 | 114 | 27.55 | 114 | 39.58 | 194 | 24.66 | 114 |
| 27.58 | 113 | 27.48 | 113 | 39.51 | 193 | 24.61 | 113 |
| 27.52 | 112 | 27.40 | 112 | 39.44 | 192 | 24.55 | 112 |
| 27.46 | 111 | 27.33 | 111 | 39.37 | 191 | 24.50 | 111 |
| 27.40 | 110 | 27.25 | 110 | 39.30 | 190 | 24.44 | 110 |
| 27.34 | 109 | 27.18 | 109 | 39.23 | 189 | 24.38 | 109 |
| 27.28 | 108 | 27.10 | 108 | 39.16 | 188 | 24.33 | 108 |
| 27.22 | 107 | 27.03 | 107 | 39.09 | 187 | 24.27 | 107 |

At step 32, the processor reads the number of doses remaining based on the measured weight. Then at step 30, the result is displayed on display 16 in window 4 to the user.

As part of step 30, the weigh scales 20 provide an output signal to the bus 18 indicative of the weight of the inhaler placed on the scales. In the above embodiment, the processor determines the number of doses remaining from a lookup table stored in memory 12, broadly corresponding to weight versus number of doses remaining data for various types of inhalers

In an alternative embodiment, it is possible to calculate the number of doses from data stored in the memory 12. In this embodiment, the input device 14 permits a user to select one of a plurality of medical inhalers stored in the memory 12. This memory also stores programming instructions as well as a data structure containing the shot weight, tare weight, and the total number of doses in a full container. Table 2 shows an exemplary data structure stored in memory 12.

The output signal is provided to processor 10, which is configured to read the shot weight, tare weight, and total number of doses from the data structure in memory 12 for the selected medical inhaler. Using these values, the processor 10 calculates the number of doses remaining in the medical inhaler by determining the measured weight as sensed by said weigh scale, subtracting the tare weight from the measured weight, and dividing the resulting net weight by the shot weight in accordance with the formula shown below.

TABLE 2

| Name | Shot Weight grams | TARE in grams | # Doses |
|---|---|---|---|
| Brand A | 0.03 | 25.5 | 200 |
| Brand B | 0.056 | 36 | 200 |
| Brand C | 0.059 | 32 | 100 |
| Brand D | 0.03 | 25.5 | 200 |
| Brand E | 0.075 | 40 | 200 |
| Brand F | 0.06 | 28 | 120 |
| Brand G | 0.075 | 28 | 120 |
| Brand H | 0.07 | 40 | 200 |
| Brand J | 0.056 | 25 | 120 |

Formula ((sample − tare)/shot) + # of doses = doses remaining

Generally, the number of doses remaining is calculated by weighing the inhaler, subtracting that weight from the tare weight of a new inhaler, and then dividing the resultant by the shot weight. In one embodiment, a set of sensitive electronic pocket scales capable of recording small measurement are used. The scales are loaded with a computer program capable of calculating the number of doses remaining in an inhaler.

The required scale sensitivity is dependent upon the type of inhaler used. For example, a scale sensitivity of 0.001 mg is ideal for measuring the contents of dry powder inhalers, or perhaps of piezoelectric inhalers, where there is no propellant or co-solvent involved, and the physical weight of the active ingredients is measured in micrograms rather than milligrams. For pMDIs, an ideal scale sensitivity is based on scales capable of measuring at least 0.01 g, and possibly 0.001 g.

It should be noted that once the inhaler has reached approximately 25 doses the size of the shot weight begins to taper off as the inhaler empties. It will continue to make sound for up to double the number of stated doses, but by weight it consistently only represents a further 10 doses.

In one embodiment, the input device also allows manual input of values as new inhalers become available. The processor would then be further configured to accept user input from said input device pertaining to the shot weight, tare weight, and total number of doses for new medical inhalers, and to add said shot weight; tare weigh, and total number of doses for said new medical inhalers to said data structure in said memory for later retrieval.

In an embodiment using mechanical scales, a set of scales is developed for each unique inhaler. The weight is read in doses rather than a unit of weight. In the electronic embodiment, each different inhaler could be programmed into the scales so that the user would simply scroll though a list and pick their inhaler, or input the unique drug identification number and the electronics would then output the correct readings.

Both mechanical and electronic versions may also be programmed or calibrated to provide an accurate inhaler dose count while the inhaler is attached to, or imbedded in another product. Such products may include but not be limited to spacers/holding chambers and leak preventing clips.

In both electronic and mechanical embodiments, the scales could be imbedded into an inhaler replicating the abilities of current dose counting inhalers, but with a greater degree of accuracy.

In preferred embodiments, the display device presents a warning characteristic when the remaining number of doses falls below a predetermined numbers. The warning characteristic may take the form of a change in color of the display For example, based on the number of doses remaining, the readout could be backlit in one color (such as green) if there was more than a two day supply of medicine left, another color (such as amber) when there were less than few days supply, and a third (such as red) indicating the published number of doses was now depleted and that the inhaler was now unreliable and should be immediately replenished. In an alternate embodiment, the user could choose the point at which the screen turns to amber, or an audible alarm could more dramatically alert the patient of the need to replenish the inhaler.

The warning can be implemented by a set of instructions stored in the memory 12, which instruct the processor to continually monitor the number Of doses remaining and create a warning flag when the number of doses remaining falls below the predetermined value. In response, to the warning flag, the processor sends an instruction to the display device 16 to change color Such a routine is shown in FIG. 4. Starting at 40, the processor reads the number of doses remaining after each measurement at step 42, compares this with a predetermined number at step 44. If the number of doses falls below the predetermined value, the processor sets the warning flag at step 46, and this can be used to change the color of the display or otherwise alert the user.

If the number is not below the predetermined number, at step 48 the processor resets the warning flag, if it is set, and returns to step 42.

Another embodiment of the dosage device contemplated comprises a second memory, and said processor is configured to store in said second memory the number of doses consumed over time to permit the amount of medication usage to be monitored. An output port may be provided for uploading said amount of medication usage to a remote monitoring site for access by a health care professional.

It should be appreciated by those skilled in the art that any block diagrams herein represent conceptual views of illustrative circuitry embodying the principles of the invention. For example, processor 10 may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

Numerous modifications may be made without departing from the spirit and scope of the invention as defined in the appended claims.

What is claimed is:

1. A dosage device for determining the number of remaining doses of medication available in a medical inhaler, comprising:
a sensitive weigh scale capable of recoding measurements at least as small as 0.001 grams for outputting a measured weight dependent on the weight of a medical inhaler placed on the weigh scale;
a memory containing a data structure in the form of a table storing a plurality of records corresponding to different medical inhalers, and each record containing data allowing the number of remaining doses to be determined from the measured weight of the inhaler or its canister;
an input device for permitting a user to select one of said plurality of medical inhalers stored in said data structure;
a processor configured to read said data stored in a record pertaining to a particular medical inhaler, and said processor being configured to determine the number of doses remaining from said stored data and the measured weight; and
a display device configured to display the remaining number of doses determined by said processor.

2. A dosage device as claimed in claim 1, wherein said memory serves as a look-up table, and said processor determines the number of doses remaining by comparing the measured weight against the values stored in the table.

3. A dosage device as claimed in claim 1, wherein said stored data in each record include shot weight, tare weight and total number of doses for each of a plurality of different medical inhalers, and wherein said processor is configured to determine the shot weight, tare weight, and total number of doses from said memory for a particular medical inhaler and to calculate the number of doses remaining in the medical inhaler by determining the measured weight as sensed by said weigh scale, subtracting the tare weight from the measured weight, and dividing the resulting net weight by thee shot weight.

4. A dosage device as claimed in claim 1, wherein said stored data in each record include shot weight, the weight of a new inhaler, tare weight and total number of doses for each of a plurality of different medical inhalers, and wherein said processor is configured to determine shot weight, new inhaler weight, tare weight, and total number of doses from said memory for a particular medical inhaler and to calculate the number of doses remaining in the medical inhaler by determining the weight as sensed by said weigh scale, subtracting the weight of a new inhaler from the measured weight, and dividing the resulting weight by the shot weight, the result of which is then added to the number of doses.

5. A device as claimed in claim 3, wherein said processor is further configured to accept user input from said input device pertaining to the shot weight, tare weight, new inhaler weight and total number of doses for new medical inhalers, and to add said shot weight, tare weight, new inhaler weight and total number of doses for said new medical inhalers to said data structure in said memory for later retrieval.

6. A device as claimed in claim 4, wherein said processor is further configured to accept user input from said input device pertaining to the shot weight, tare weight, new inhaler weight and total number of doses for new medical inhalers, and to add said shot weight, tare weight, new inhaler weight and total number of doses for said new medical inhalers to said data structure in said memory for later retrieval.

7. A device as claimed in claim 1, wherein said display device presents a warning characteristic when the remaining number of doses falls below a first predetermined number.

8. A device as claimed in claim 7, wherein said warning characteristic takes the form of a change in color of the display.

9. A device as claimed in claim 7, wherein said display device presents a second warning characteristic when the remaining number of doses falls below a second predetermined number.

10. A device as claimed in claim 9, wherein the display turns amber when the remaining number of doses falls below the first predetermined number and red when the remaining number of doses falls below the second predetermined number.

11. A device as claimed in claim 1, further comprising a second memory, and said processor is configured to store in said second memory the number of doses consumed over time by any of said plurality of medical inhalers stored in said data structure to permit the amount of medication usage to be monitored.

12. A device as claimed in claim 11, further comprising an output port for uploading said amount of medication usage to a remote monitoring site for access by a health care professional.

13. A device as claimed in claim 1, wherein said weigh scale is an electronic weigh scale.

14. A device as claimed in claim 11 wherein the inhaler is a meter dose inhaler (pDMI)

15. A dosage device for determining the number of remaining doses of medication available in a medical inhaler, comprising:
a sensitive weigh scale capable of recoding measurements at least as small as 0.001 grams;
a readout calibrated to display the number of doses remaining in the medical inhaler based on the measured weight and the known properties of the inhaler.

16. A dosage device as claimed in claim 15, wherein the readout is a mechanical readout.
